(19) United States
(12) Patent Application Publication
(10) Pub. No.: US 2026/0209392 A1
(43) Pub. Date: Jul. 23, 2026

(54) CELLULOSE FINE FIBER COMPOSITION, AQUEOUS DISPERSION OF CELLULOSE FINE FIBER, POLYMER COMPOSITION, MOLDED ARTICLE AND METHOD FOR PRODUCING CELLULOSE FINE FIBER COMPOSITION

(71) Applicant: Yokogawa Electric Corporation, Tokyo (JP)

(72) Inventors: Makoto MOCHIDUKI, Tokyo (JP); Takahiro SAKO, Tokyo (JP); Takeshi SUZUKI, Tokyo (JP); Shinichiro IWAMOTO, Tokyo (JP); Ryotaro TANI, Tokyo (JP); Noriaki EGAWA, Tokyo (JP); Tomofumi YOKOMIZO, Tokyo (JP)

(21) Appl. No.: 19/157,814

(22) PCT Filed: Feb. 8, 2024
(86) PCT No.: PCT/JP2024/004279

§ 371 Date: Aug. 19, 2025

(30) Foreign Application Priority Data
Feb. 20, 2023 (JP) 2023-023948

(51) Int. Cl. C08B 5/14; C08K 3/16; C08K 3/30; C08K 3/32; C08K 3/34; C08K 3/38; C08K 5/098; C08L 1/16

(52) U.S. Cl. CPC C08B 5/14; C08K 3/16; C08K 3/30; C08K 3/32; C08K 3/34; C08K 3/38; C08K 5/098; C08L 1/16; C08K 2003/3045; C08K 2003/387

(57) ABSTRACT

An object of the present disclosure is to provide a cellulose fine fiber composition having excellent film formability when a molded article including cellulose fine fiber, such as film, is produced, an aqueous dispersion of cellulose fine fiber, a polymer composition prepared by using them, a molded article and a method for producing a cellulose fine fiber composition. An aspect of the present embodiments is a cellulose fine fiber composition including cellulose fine fiber and one or more salts selected from a metal salt and an ammonium salt, wherein the cellulose fine fiber has an average fiber width of 1 nm or more and 1,000 nm or less, the cellulose fine fiber has a sulfuric acid ester group represented by the following general formula (1), the cellulose fine fiber has an amount of sulfur derived from the sulfuric acid ester group of 0.3 mmol/g or more and 3.0 mmol/g or less introduced into the cellulose fine fiber, and the cellulose fine fiber composition includes 0.002 part by mass or more and 10 parts by mass or less of the salt based on 100 parts by mass of the cellulose fine fiber.

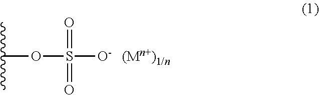

### TECHNICAL FIELD

The present disclosure relates to a cellulose fine fiber composition, an aqueous dispersion of cellulose fine fiber, a polymer composition, a molded article and a method for producing a cellulose fine fiber composition.

### BACKGROUND ART

Growing environmental awareness has led to the development of studies around the world aimed at the practical application of biomass-derived materials. For example, much of the cellulose extracted from wood (wood chips) is used to make paper, which contributes significantly to both people's lives and CO₂ fixation.

There is growing momentum for the use of biomass-derived materials in the paint, coating, and cosmetic industries. Furthermore, there is growing momentum to utilize biomass-derived materials in the production of raw materials used in these industries. In these and many other fields, there is a need to replace organic solvents that are harmful to the human body with aqueous solvents from the standpoint of safety and quality of life.

Among cellulose, cellulose nanofibers are used or desired to be used in many fields. Cellulose nanofibers are biomass-derived compounds made from cellulose fibers that have been defibrated to nanosize. They are well dispersed in water, and a transparent nanocellulose film can be easily obtained by drying the dispersion. In addition, when mixed with resin or rubber, cellulose nanofibers improve various properties such as strength, flexibility, and elongation, and are attracting attention as an environmentally friendly new material, and various proposals have been made in the past.

For example, Patent Literature 1 discloses a metal salt-containing cellulose nanofiber comprising cellulose nanofiber, a metal salt and a silicon atom-containing hy-drophobizing agent. Patent Literature 1 discloses, as a cellulose nanofiber, an oxidized cellulose nanofiber in which hydroxyl groups of the cellulose molecule are oxidized using 2,2,6,6-tetramethylpiperidine-N-oxyl (hereinafter “TEMPO”) as a catalyst. Patent Literature 1 discloses that the metal salt-containing cellulose nanofiber can be easily and uniformly dispersed in resin compositions and rubber compositions, and that the addition thereof to the composition can improve the physical properties of resin and rubber.

### CITATION LIST

### Patent Literature

PTL 1 JP 2019-094460 A

### SUMMARY OF INVENTION

### Technical Problem

In general, cellulose nanofibers have a fiber length of from several hundred nm to at maximum several tens of micrometers and a fiber width of from 1 nm to several hundred nm. When manufacturing a cellulose nanofiber film using an aqueous dispersion of cellulose nanofiber, coating film is locally separated from the base material during drying after the aqueous dispersion is applied, and therefore improvement in film formability has been sought.

Accordingly, an object of the present disclosure is to provide a cellulose fine fiber composition having excellent film formability when a molded article including cellulose fine fiber, such as film, is produced, an aqueous dispersion of cellulose fine fiber, a polymer composition prepared by using them, a molded article and a method for producing a cellulose fine fiber composition.

### Solution to Problem

The present inventors have conducted intensive studies for solving the above problem and as a result have found that a highly smooth molded article can be prepared by using a cellulose fine fiber composition comprising a specific salt and an aqueous dispersion of cellulose fine fiber comprising a specific salt, and have arrived at the present disclosure.

Aspects of the present embodiments are as follows.
(1) A cellulose fine fiber composition comprising cellulose fine fiber and one or more salts selected from a metal salt and an ammonium salt, wherein
the cellulose fine fiber has an average fiber width of 1 nm or more and 1,000 nm or less,
the cellulose fine fiber has a sulfuric acid ester group represented by the following general formula (1),
the cellulose fine fiber has an amount of sulfur derived from the sulfuric acid ester group of 0.3 mmol/g or more and 3.0 mmol/g or less introduced into the cellulose fine fiber, and
the cellulose fine fiber composition comprises 0.002 part by mass or more and 10 parts by mass or less of the salt based on 100 parts by mass of the cellulose fine fiber:

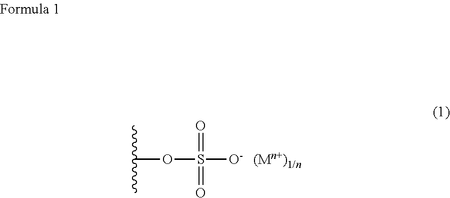

(in the general formula (1), n is an integer of 1 or more and 3 or less, Mⁿ⁺ is an n-valent cation, and the wavy line indicates a bonding site with another atom).
(2) The cellulose fine fiber composition according to (1), wherein the salt is one or more salts selected from a sulfate, a carboxylate, a borate, a phosphate and an ammonium salt.
(3) The cellulose fine fiber composition according to (1) or (2), having a water content of 10% by mass or less.
(4) The cellulose fine fiber composition according to any of (1) to (3), which is in a powdery form.
(5) An aqueous dispersion of cellulose fine fiber, comprising cellulose fine fiber, one or more salts selected from a metal salt and an ammonium salt, and water, wherein
the cellulose fine fiber has an average fiber width of 1 nm or more and 1,000 nm or less,
the cellulose fine fiber has a sulfuric acid ester group represented by the following general formula (1),
the cellulose fine fiber has an amount of sulfur derived from the sulfuric acid ester group of 0.3 mmol/g or more and 3.0 mmol/g or less introduced into the cellulose fine fiber,
the aqueous dispersion of cellulose fine fiber comprises 0.002 part by mass or more and 10 parts by mass or less of the salt based on 100 parts by mass of the cellulose fine fiber and
the aqueous dispersion of cellulose fine fiber comprises 10 parts by mass or more of water based on 1 part by mass of the total amount of the cellulose fine fiber and the salts:

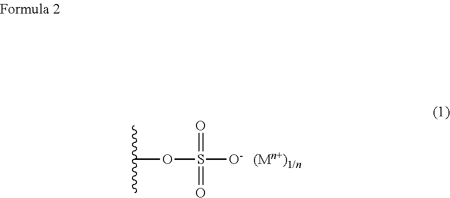

(in the general formula (1), n is an integer of 1 or more and 3 or less, Mⁿ⁺ is an n-valent cation, and the wavy line indicates a bonding site with another atom).
(6) The aqueous dispersion of cellulose fine fiber according to (5), wherein the salt is one or more salts selected from a sulfate, a carboxylate, a borate, a phosphate and an ammonium salt.
(7) The aqueous dispersion of cellulose fine fiber according to (5) or (6), comprising at least one or more compounds selected from a monomer, a prepolymer and a polymer.
(8) The aqueous dispersion of cellulose fine fiber according to (7), comprising 400 parts by mass or more and 20,000 parts by mass or less of the at least one or more compounds selected from a monomer, a prepolymer and a polymer based on 100 parts by mass of the cellulose fine fiber.
(9) A polymer composition comprising cellulose fine fiber, one or more salts selected from a metal salt and an ammonium salt and a polymer, wherein
the cellulose fine fiber has an average fiber width of 1 nm or more and 1,000 nm or less,
the cellulose fine fiber has a sulfuric acid ester group represented by the following general formula (1),
the cellulose fine fiber has an amount of sulfur derived from the sulfuric acid ester group of 0.3 mmol/g or more and 3.0 mmol/g or less introduced into the cellulose fine fiber, and
the polymer composition comprises 0.002 part by mass or more and 10 parts by mass or less of the salt based on 100 parts by mass of the cellulose fine fiber:

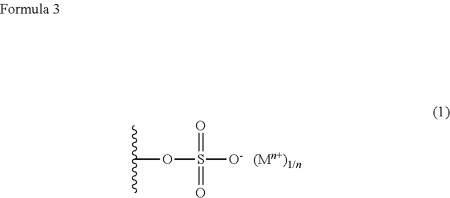

(in the general formula (1), n is an integer of 1 or more and 3 or less, Mⁿ⁺ is an n-valent cation, and the wavy line indicates a bonding site with another atom).
(10) The polymer composition according to (9), wherein the salt is one or more salts selected from a sulfate, a carboxylate, a borate, a phosphate and an ammonium salt.
(11) The polymer composition according to (9) or (10), comprising 400 parts by mass or more and 20,000 parts by mass or less of the polymer based on 100 parts by mass of the cellulose fine fiber.
(12) A molded article comprising a layer formed from the polymer composition according to any of (9) to (11).
(13) A method for producing a cellulose fine fiber composition, the method comprising the steps of:
preparing an aqueous dispersion of cellulose fine fiber by mixing an aqueous solution of one or more salts selected from a metal salt and an ammonium salt with cellulose fine fiber; and
drying the aqueous dispersion of cellulose fine fiber to obtain a cellulose fine fiber composition comprising the cellulose fine fiber and one or more salts selected from a metal salt and an ammonium salt, wherein
the cellulose fine fiber has an average fiber width of 1 nm or more and 1,000 nm or less,
the cellulose fine fiber has a sulfuric acid ester group represented by the following general formula (1),
the cellulose fine fiber has an amount of sulfur derived from the sulfuric acid ester group of 0.3 mmol/g or more and 3.0 mmol/g or less introduced into the cellulose fine fiber, and
in the step of preparing an aqueous dispersion of cellulose fine fiber, 0.002 part by mass or more and 10 parts by mass or less of the salt based on 100 parts by mass of the cellulose fine fiber is used:

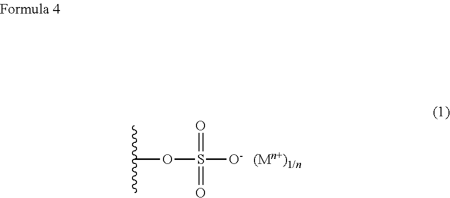

(in the general formula (1), n is an integer of 1 or more and 3 or less, Mⁿ⁺ is an n-valent cation, and the wavy line indicates a bonding site with another atom).

The present specification encompasses the contents disclosed in Japanese Patent Application No. 2023-023948 to which the present application claims the priority.

### Advantageous Effects of Invention

The present disclosure can provide a cellulose fine fiber composition having excellent film formability when a molded article including cellulose fine fiber, such as film, is produced, an aqueous dispersion of cellulose fine fiber, a polymer composition prepared by using them, a molded article and a method for producing a cellulose fine fiber composition.

### DESCRIPTION OF EMBODIMENTS

The cellulose fine fiber composition, aqueous dispersion of cellulose fine fiber, polymer composition, molded article and method for producing a cellulose fine fiber composition of the present embodiment will be described in detail.

An aspect of the present embodiment is a cellulose fine fiber composition comprising cellulose fine fiber and one or more salts selected from a metal salt and an ammonium salt, wherein the cellulose fine fiber has an average fiber width of 1 nm or more and 1,000 nm or less, the cellulose fine fiber has a sulfuric acid ester group represented by the following general formula (1), the cellulose fine fiber has an amount of sulfur derived from the sulfuric acid ester group of 0.3 mmol/g or more and 3.0 mmol/g or less introduced into the cellulose fine fiber, and the cellulose fine fiber composition comprises 0.002 part by mass or more and 10 parts by mass or less of the salt based on 100 parts by mass of the cellulose fine fiber.

An aspect of the present embodiment is an aqueous dispersion of cellulose fine fiber, comprising cellulose fine fiber, one or more salts selected from a metal salt and an ammonium salt, and water, wherein the cellulose fine fiber has an average fiber width of 1 nm or more and 1,000 nm or less, the cellulose fine fiber has a sulfuric acid ester group represented by the following general formula (1), the cellulose fine fiber has an amount of sulfur derived from the sulfuric acid ester group of 0.3 mmol/g or more and 3.0 mmol/g or less introduced into the cellulose fine fiber, the aqueous dispersion of cellulose fine fiber comprises 0.002 part by mass or more and 10 parts by mass or less of the salt based on 100 parts by mass of the cellulose fine fiber, and the aqueous dispersion of cellulose fine fiber comprises 10 parts by mass or more of water based on 1 part by mass of the total amount of the cellulose fine fiber and the salts.

An aspect of the present embodiment is a polymer composition comprising cellulose fine fiber, one or more salts selected from a metal salt and an ammonium salt and a polymer, wherein the cellulose fine fiber has an average fiber width of 1 nm or more and 1,000 nm or less, the cellulose fine fiber has a sulfuric acid ester group represented by the following general formula (1), the cellulose fine fiber has an amount of sulfur derived from the sulfuric acid ester group of 0.3 mmol/g or more and 3.0 mmol/g or less introduced into the cellulose fine fiber, and the polymer composition comprises 0.002 part by mass or more and 10 parts by mass or less of the salt based on 100 parts by mass of the cellulose fine fiber.

An aspect of the present embodiment is a molded article comprising a layer formed from the polymer composition.

An aspect of the present embodiment is a method for producing a cellulose fine fiber composition, the method comprising the steps of: preparing an aqueous dispersion of cellulose fine fiber by mixing an aqueous solution of one or more salts selected from a metal salt and an ammonium salt with cellulose fine fiber, and drying the aqueous dispersion of cellulose fine fiber to obtain a cellulose fine fiber composition comprising the cellulose fine fiber and one or more salts selected from a metal salt and an ammonium salt, wherein the cellulose fine fiber has an average fiber width of 1 nm or more and 1,000 nm or less, the cellulose fine fiber has a sulfuric acid ester group represented by the following general formula (1), the cellulose fine fiber has an amount of sulfur derived from the sulfuric acid ester group of 0.3 mmol/g or more and 3.0 mmol/g or less introduced into the cellulose fine fiber, and in the step of preparing an aqueous dispersion of cellulose fine fiber, 0.002 part by mass or more and 10 parts by mass or less of the salt is used based on 100 parts by mass of the cellulose fine fiber.

The cellulose fine fiber composition and the aqueous dispersion of cellulose fine fiber of the present embodiment have excellent film formability when a molded article including cellulose fine fiber, such as film, is produced. Since local separation is suppressed in the polymer composition and the molded article prepared using them, they are easily formed into a desired shape.

In the following, the present embodiment will be described in detail.

### Cellulose Fine Fiber

The cellulose fine fiber composition, the aqueous dispersion of cellulose fine fiber, the polymer composition and the molded article of the present embodiment comprise a cellulose fine fiber; and the cellulose fine fiber is used in the method for producing a cellulose fine fiber composition of the present embodiment. Typical cellulose (unmodified celluloses) is polysaccharide with glucose linked by beta-1,4-glycoside bonding and is represented by (C₆H₁₀O₅)ₙ. The cellulose fine fiber in the present embodiment is made of modified cellulose, as is evident from the fact that the cellulose fine fiber has a sulfuric acid ester group.

The cellulose fine fiber has an average fiber width of 1 nm to 1,000 nm, preferably 1 nm to 100 nm and more preferably 2 nm to 10 nm. The average fiber length of the cellulose fine fiber is not particularly limited, and the cellulose fine fiber has an average fiber length of usually 0.1 micrometer to 6 micrometers, and preferably 0.1 micrometer to 2 micrometers.

The average fiber width and the average fiber length may be calculated by measuring the fiber width (fiber diameter (circle equivalent diameter)) and the fiber length of 50 pieces of fiber randomly selected using, for example, an atomic force microscope (SPM-9700HT manufactured by SHIMADZU CORPORATION), and arithmetically averaging the values, respectively. The average fiber width and the average fiber length may be set to a desired range by adjusting the time of sulfuric acid esterification or the blending ratio of the reagent.

The cellulose fine fiber has a sulfuric acid ester group represented by the following general formula (1). The cellulose fine fiber may also be referred to as cellulose nanofiber esterified with sulfuric acid. A sulfuric acid ester group is usually introduced into cellulose fine fiber by substitution of part of the OH groups in cellulose constituting the fiber by a sulfuric acid ester group represented by the following general formula (1). The cellulose fine fiber may be produced, for example, by sulfuric acid esterification and defibration of raw material pulp as shown in Examples.

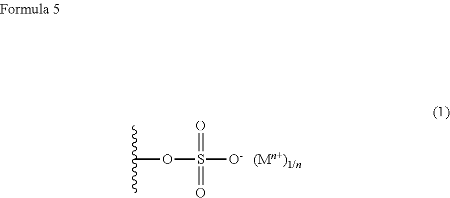

(in the general formula (1), n is an integer of 1 to 3, Mⁿ⁺ is an n-valent cation, and the wavy line indicates a bonding site with another atom).

Examples of Mⁿ⁺ include a hydrogen ion (H⁺), a metal ion and an ammonium ion. When n is 2 or 3, that is, Mⁿ⁺ is a polyvalent cation, Mⁿ⁺ form an ionic bond between two or three —OSO₃⁻ ions. It is one preferable aspect that for Mⁿ⁺, n is 1 and Mⁿ⁺ is M⁺ (a monovalent cation).

Examples of metal ions include an alkali metal ion, an alkaline earth metal ion, a transition metal ion and other metal ions.

Examples of alkali metal ions include lithium ion (Li⁺), sodium ion (Na⁺), potassium ion (K⁺), rubidium ion (Rb⁺) and cesium ion (Cs⁺). Examples of alkaline earth metal ions include calcium ion (Ca²⁺) and strontium ion (Sr²⁺). Examples of transition metal ions include iron ion, nickel ion, palladium ion, copper ion and silver ion. Examples of other metal ions include beryllium ion, magnesium ion, zinc ion and aluminum ion.

Examples of ammonium ions include not only NH₄⁺ but also an ammonium ion derived from various amines, in which one or more hydrogen atoms in NH₄⁺ is substituted by an organic group. Examples of ammonium ions include NH₄⁺, a quaternary ammonium cation, an alkanol amine ion and a pyridinium ion.

Mⁿ⁺ is preferably a hydrogen ion, a sodium ion, a potassium ion, a calcium ion or a quaternary ammonium cation, and more preferably a hydrogen ion, a sodium ion, a potassium ion or a calcium ion, and particularly preferably a sodium ion (Na⁺) from the viewpoint of processability of cellulose fine fiber solid in various applications. The sulfuric acid ester group represented by the above general formula (1) may have one kind of Mⁿ⁺ or 2 or more of them.

When a sulfuric acid ester group is introduced into cellulose fine fiber by substitution of part of the OH groups in cellulose constituting fiber by a sulfuric acid ester group represented by the general formula (1), the wavy line indicates the bonding site to a carbon atom to which the OH group has been bonded.

The cellulose fine fiber may have a substituent different from the sulfuric acid ester group represented by the above general formula (1). When the cellulose fine fiber has a group different from the sulfuric acid ester group represented by the above general formula (1), i.e., another substituent, at least one OH group in cellulose usually constituting the cellulose fine fiber is substituted by the other substituent. Examples of other substituents include, but are not particularly limited to, an anionic substituent and a salt thereof, an ester group, an ether group, an acyl group, an aldehyde group, an alkyl group, an alkylene group, an aryl group and a combination of two or more of them. When another substituent is a combination of two or more substituents, the content ratio of the respective substituents is not limited. Of them, an anionic substituent and a salt thereof and an acyl group are preferred as the other substituents from the viewpoint of nano-dispersibility. In particular, a carboxyl group, a phosphate group, a phosphite group and a xanthate group are preferred as an anionic substituent and a salt thereof. When the anionic substituent is in the form of a salt, a sodium salt, a potassium salt and a calcium salt are particularly preferred from the viewpoint of nano dispersibility. Furthermore, an acetyl group is particularly preferred as an acyl group from the viewpoint of nano-dispersibility.

The amount of sulfur derived from a sulfuric acid ester group introduced into the cellulose fine fiber is 0.3 mmol/g or more and 3.0 mmol/g or less. The amount of a sulfuric acid ester group introduced may be set to an optional, suitable value within the above range depending on applications or the like. The amount of sulfur derived from the sulfuric acid ester group introduced into the cellulose fine fiber may be represented by the content ratio of sulfur (mmol) per 1 g of the cellulose fine fiber. It is preferable that the amount of sulfur introduced be 0.5 mmol/g or more and 3.0 mmol/g or less. It is more preferable that the amount of sulfur introduced be 0.7 mmol/g or more and 3.0 mmol/g or less. An amount of sulfur introduced within the above range is preferred because the cellulose fine fiber composition is likely to be highly water dispersible.

The amount of sulfur introduced may be determined, for example, by combustion ab-sorption-ion chromatography (IC) (combustion absorption-IC, combustion IC) described in Examples. The amount of sulfur introduced may be adjusted, for example, by controlling the concentration of a reagent such as sulfuric acid in a solution used for defibrating pulp (defibration solution), the amount of pulp relative to the defibration solution, the reaction time and the reaction temperature.

### Salt

The cellulose fine fiber composition, the aqueous dispersion of cellulose fine fiber, the polymer composition and the molded article of the present embodiment comprise one or more salts selected from a metal salt and an ammonium salt. One or more salts selected from a metal salt and an ammonium salt are used in the method for producing a cellulose fine fiber composition of the present embodiment. One of the salts may be used, or two or more of them may be used. In a preferred aspect, the salt is one or more salts selected from a sulfate, a carboxylate, a borate, a phosphate and an ammonium salt.

Examples of sulfates include one or more salts selected from sodium sulfate, potassium sulfate, magnesium sulfate, calcium sulfate, barium sulfate, strontium sulfate, silver (I) sulfate and ammonium sulfate.

Carboxylates are a salt of a compound having one or more carboxyl groups per molecule (carboxylic acid) and a base. Carboxylates are not particularly limited, and if a composite with polymer (e.g., rubber or resin) is to be formed, it is preferable to use a carboxylate soluble both in water and an organic solvent. Examples of carboxylic acids include aliphatic carboxylic acids such as formic acid, acetic acid, propionic acid, butyric acid, valeric acid, 3-chloropropionic acid and 2-chloropropionic acid, hydroxy-carboxylic acids such as lactic acid, 3-hydroxybutyric acid, 4-hydroxybutyric acid and mandelic acid, and aliphatic heterocyclic carboxylic acids. A preferred aspect of carboxylic acid includes acetic acid. Aliphatic heterocyclic carboxylic acids is a compound in which a carboxyl group is bonded to an aliphatic heterocyclic ring, and a substituent other than a carboxylic acid may be included. Examples of bases which form a salt with a carboxylic acid include an alkali metal ion such as sodium ion, potassium ion and lithium ion, an alkaline earth metal ion such as calcium ion, and amines such as methylamine, ethylamine and triethylamine. Preferred aspects of carboxylate include sodium carboxylate and calcium carboxylate.

A borate is a salt of boric acid (B(OH) 3), or a metaboric acid or polyboric acid formed by dehydration condensation of boric acid with an alkali metal, an alkaline earth metal or ammonium. Examples of borates include sodium tetraborate, lithium tetraborate, potassium tetraborate, calcium tetraborate, sodium metaborate, potassium metaborate, lithium metaborate, calcium metaborate and ammonium tetraborate.

A phosphate is a salt of phosphoric acid (PO₄³⁻) or polyphosphoric acid, which is polymer of phosphoric acid, with an alkali metal, an alkaline earth metal or ammonium. Examples of phosphates include sodium phosphate, potassium phosphate, calcium phosphate, lithium phosphate, ammonium phosphate, sodium polyphosphate, potassium polyphosphate, calcium polyphosphate, lithium polyphosphate and ammonium polyphosphate.

An ammonium salt is represented by NH₄X (X is a monovalent base) or NR₄X (R is each independently a hydrogen atom or an alkyl group, X is a monovalent base). X, for example, is preferably a halogen ion, a sulfate ion, an acetate ion, a nitrate ion or a hydroxide ion from the viewpoint of dispersibility. R is preferably each independently an alkyl group having 1 to 4 carbon atoms from the viewpoint of high dispersibility when compounding with polymer (e.g., rubber or resin). Examples of ammonium salts include ammonium sulfate, ammonium acetate, ammonium formate, tetramethy-lammonium chloride, tetraethylammonium chloride and tetraethylammonium hydroxide.

### Cellulose Fine Fiber Composition

The cellulose fine fiber composition of the present embodiment comprises cellulose fine fiber and one or more salts selected from a metal salt and an ammonium salt, and comprises 0.002 part by mass or more and 10 parts by mass or less of the salt based on 100 parts by mass of the cellulose fine fiber. The cellulose fine fiber composition may include a component other than the cellulose fine fiber and the salt, or may include only the cellulose fine fiber and the salt. Furthermore, the cellulose fine fiber composition may not be completely free of water, and usually includes a small amount of water.

The water content of the cellulose fine fiber composition of the present embodiment varies depending on components included in the cellulose fine fiber composition, in particular the type and the amount of components other than the cellulose fine fiber and the salt. The cellulose fine fiber composition of the present embodiment, for example, may have a water content of 10% by mass or less, 7% by mass or less, or 5% by mass or less. The lower limit of the water content of the cellulose fine fiber composition is not particularly limited, and for example, may be 1% by mass or more, or 3% by mass or more. In particular, when the cellulose fine fiber composition of the present embodiment is composed of the cellulose fine fiber, the salt and water as the main component, more specifically when the cellulose fine fiber composition includes a total of 95% by mass or more, preferably 97% by mass or more of the cellulose fine fiber, the salt and water based on 100% by mass of the cellulose fine fiber composition, the water content is in the above range in a preferred aspect. Usually, the cellulose fine fiber composition of the present embodiment has a solid appearance. In the present disclosure, water is for example tap water, ion-exchanged water, distilled water, purified water and natural water, and tap water, ion-exchanged water, distilled water and purified water are preferred, and ion-exchanged water, distilled water and purified water are more preferred.

The water content of the cellulose fine fiber composition may be determined, for example, according to JIS P8203.

The amount of the cellulose fine fiber in the cellulose fine fiber composition is usually 70% by mass or more, preferably 90% by mass or more and more preferably 95% by mass or more. The amount of the cellulose fine fiber is preferably 99% by mass or less and more preferably 97% by mass or less.

The amount of the salt contained in the cellulose fine fiber composition is 0.002 part by mass or more and 10 parts by mass or less, preferably 0.01 part by mass or more and 5 parts by mass or less, and more preferably 0.02 part by mass or more and 1 part by mass or less based on 100 parts by mass of the cellulose fine fiber. The above range is preferred because separation is suppressed when film is formed and dispersibility is also achieved when an aqueous dispersion is prepared.

The form of the cellulose fine fiber composition is not particularly limited, and it may be in a powdery, a chip, a flake and a film form, and a powdery form is preferred. The powder refers to a powder with a median diameter of 0.1 to 1,000 micrometers, for example. The median diameter of the cellulose fine fiber composition may be measured, for example, by using a dry particle size analyzer in accordance with ISO 13320 and JIS Z 8825, which are the standard of the laser diffraction scattering method. The powdery form means the cellulose fine fiber and salt agglomerated in a powdery form, and does not mean cellulose particles.

The cellulose fine fiber composition includes the cellulose fine fiber and the salt described above, and may include water. The cellulose fine fiber composition may include a component other than the cellulose fine fiber and the salt. When the cellulose fine fiber composition includes a component other than the cellulose fine fiber and the salt, the cellulose fine fiber composition may include an additive. The additive may be an inorganic additive or an organic additive.

Examples of inorganic additives include inorganic fine particles. Examples of inorganic fine particles include silica, mica, talc, clay, carbon and a carbonate (e.g., calcium carbonate, magnesium carbonate), an oxide (e.g., aluminum oxide, titanium oxide, zinc oxide, iron oxide), ceramics (e.g., ferrite), and fine particles of a mixture thereof. The cellulose fine fiber composition may include, for example, 0.09 to 5% by mass of inorganic fine particles.

The cellulose fine fiber composition may include a functional compound as an organic additive. Examples of functional compounds include a pigment, a UV absorbent, an antioxidant, an antistatic agent and a surfactant. The cellulose fine fiber composition may include, for example, 0.09 to 5% by mass of an organic additive.

The cellulose fine fiber composition of the present embodiment may be used in various applications, for example, in the form of an aqueous dispersion of cellulose fine fiber described later. The cellulose fine fiber composition of the present embodiment may be used as a material for preparing a molded article such as film and sheet, for example, by the method described in Examples. In other words, in an embodiment, the cellulose fine fiber composition is a cellulose fine fiber composition for a molded article (e.g., a cellulose fine fiber composition for forming film and sheet). The present disclosure also includes use of the cellulose fine fiber composition for producing a molded article and use of the cellulose fine fiber composition for producing film and sheet.

### Method for Producing Cellulose Fine Fiber Composition

The method for producing a cellulose fine fiber composition of the present embodiment comprises the steps of: preparing an aqueous dispersion of cellulose fine fiber by mixing an aqueous solution of one or more salts selected from a metal salt and an ammonium salt with cellulose fine fiber, and drying the aqueous dispersion of cellulose fine fiber to obtain a cellulose fine fiber composition comprising the cellulose fine fiber and one or more salts selected from a metal salt and an ammonium salt. In the step for preparing an aqueous dispersion of cellulose fine fiber, 0.002 part by mass or more and 10 parts by mass or less of the salt is used based on 100 parts by mass of the cellulose fine fiber. The above cellulose fine fiber composition may be prepared by the producing method of the present embodiment.

In the step of preparing an aqueous dispersion, for example an aqueous solution of one or more salts selected from a metal salt and an ammonium salt previously prepared is mixed with cellulose fine fiber. While the cellulose fine fiber used in the above step may be a solid cellulose fine fiber (e.g., powder), an aqueous dispersion of cellulose fine fiber to which none of the above salts are added may be prepared separately from the above aqueous solution of the salt, and the aqueous solution of the salt may be mixed with the aqueous dispersion of cellulose fine fiber to which none of the above salts are added to perform the above step of preparing an aqueous dispersion.

Furthermore, in the step of preparing an aqueous dispersion of cellulose fine fiber, 0.002 part by mass or more and 10 parts by mass or less of the salt is used based on 100 parts by mass of the cellulose fine fiber. It is preferable to use 0.01 part by mass or more and 5 parts by mass or less of the salt, and it is more preferable to use 0.02 part by mass or more and 1 part by mass or less of the salt. The above range is preferred because the resulting aqueous dispersion has excellent dispersibility.

The concentration of the cellulose fine fiber in the aqueous dispersion prepared in the step of preparing an aqueous dispersion of cellulose fine fiber is not particularly limited. The concentration is usually 0.05 to 10% by mass, and preferably 0.3 to 2% by mass. The aqueous dispersion of cellulose fine fiber prepared in the step of preparing an aqueous dispersion comprises preferably 10 parts by mass or more, more preferably 90 parts by mass or more, and particularly preferably 98 parts by mass or more of water based on 1 part by mass of the total amount of the cellulose fine fiber and the salt. The upper limit of the amount of water is not particularly limited. The aqueous dispersion of cellulose fine fiber prepared in the step of preparing an aqueous dispersion comprises preferably 99.9 parts by mass or less, and more preferably 99.5 parts by mass or less of water based on 1 part by mass of the total amount of the cellulose fine fiber and the salt from the viewpoint of handling properties.

The aqueous dispersion of cellulose fine fiber prepared without mixing salt may be prepared, for example, by introducing a sulfuric acid ester group by the method described in Examples when defibrating cellulose fiber to nanosize, purifying and dispersing in water.

In the step of preparing a cellulose fine fiber composition, the cellulose fine fiber composition comprising one or more salts selected from a metal salt and an ammonium salt may be obtained by removing (drying) the dispersion medium from the aqueous dispersion of cellulose fine fiber. A known method may be used as the method of drying, and the method is not particularly limited. Examples thereof include lyophilization, spray drying, squeezing, air drying, hot air drying, crystallization and vacuum drying. The dryer is not particularly limited, and examples thereof include freeze drying apparatus, a conical dryer, a continuous tunnel dryer, a band dryer, a vertical dryer, a vertical turbo-dryer, a multistage disc dryer, a through-flow dryer, a rotary dryer, a flash dryer, a spray dryer, a cylindrical dryer, a drum dryer, a belt dryer, a screw conveyor dryer, a rotary dryer with a tube furnace, a vibrating conveyor dryer, a batch box dryer, a vacuum box dryer and stirring dryer. The dryers may be used singly or in combination of two or more. The method of drying is preferably lyophilization because it takes only short time and suppresses the risk of degradation due to heat.

The cellulose fine fiber composition may be pulverized using a dry pulverizer or the like where necessary. The cellulose fine fiber composition may be formed into a powder with a desired size, and used, stored and distributed.

The cellulose fine fiber composition prepared by the method for producing a cellulose fine fiber composition may comprise a component other than the cellulose fine fiber, salt and water. More specifically, the cellulose fine fiber composition may comprise the additive described in the above section of (Cellulose fine fiber composition).

### Aqueous Dispersion of Cellulose Fine Fiber

The aqueous dispersion of cellulose fine fiber of the present embodiment comprises cellulose fine fiber, one or more salts selected from a metal salt and an ammonium salt, and water, and comprises 0.002 part by mass or more and 10 parts by mass or less of the salt based on 100 parts by mass of the cellulose fine fiber, and comprises 10 parts by mass or more of water based on 1 part by mass of the total amount of the cellulose fine fiber and the salts. The aqueous dispersion of cellulose fine fiber may include a component other than the cellulose fine fiber, the salt and water, or may include only the cellulose fine fiber, the salt and water.

The amount of the salt contained in the aqueous dispersion of cellulose fine fiber is 0.002 part by mass or more and 10 parts by mass or less, preferably 0.01 part by mass or more and 5 parts by mass or less, and more preferably 0.02 part by mass or more and 1 part by mass or less based on 100 parts by mass of the cellulose fine fiber. The above range is preferred because the resulting aqueous dispersion has excellent dispersibility.

The aqueous dispersion of cellulose fine fiber comprises 10 parts by mass or more, preferably 90 parts by mass or more, and more preferably 98 parts by mass or more of water based on 1 part by mass of the total amount of the cellulose fine fiber and the salt. The upper limit of the amount of water is not particularly limited. The aqueous dispersion of cellulose fine fiber comprises preferably 99.9 parts by mass or less, and more preferably 99.5 parts by mass or less of water based on 1 part by mass of the total amount of the cellulose fine fiber and the salt from the viewpoint of handling properties.

The aqueous dispersion of cellulose fine fiber of the present embodiment may include a component other than the cellulose fine fiber, the salt and water. Various components to be blended in an aqueous composition in the field of materials, paint, coating and cosmetics, etc. may be used as the component other than the cellulose fine fiber, the salt and water, depending on the application of the aqueous dispersion of cellulose fine fiber. More specifically, the aqueous dispersion of cellulose fine fiber may comprise the additive described in the above section of (Cellulose fine fiber composition).

The aqueous dispersion of cellulose fine fiber of the present embodiment may comprise at least one or more compounds selected from a monomer, a prepolymer and a polymer. In this aspect, at the time of application of the aqueous dispersion of cellulose fine fiber to form a layer with a monomer or a prepolymer, a layer formed from a polymer composition, more specifically a composition comprising cellulose fine fiber, salt and a polymer, may be obtained by performing the process under conditions in which polymerization proceeds. Alternatively, at the time of application of the aqueous dispersion of cellulose fine fiber to form a layer, the process may be performed under conditions in which cross-linking proceeds so that the resulting polymer composition includes a cross-linked rubber.

Examples of polymers include at least one polymer selected from a resin and a rubber, such as a phenol resin, a melamine resin, a urea resin, an alkyd resin, an epoxy resin, an unsaturated polyester resin, a polyurethane resin, a polyethylene resin (e.g., high density polyethylene, medium density polyethylene, low density polyethylene), a polypropylene resin, a polystyrene resin, an acrylic resin, polyvinyl alcohol, an acrylamide resin, a silicone resin, a natural rubber and a synthetic rubber. Examples of monomers and prepolymers include a monomer and prepolymer which form the above polymer by polymerization.

When the aqueous dispersion of cellulose fine fiber of the present embodiment comprises at least one or more compounds selected from a monomer, a prepolymer and a polymer, preferably 400 parts by mass or more and 20,000 parts by mass or less, more preferably 10,000 parts by mass or more and 15,000 parts by mass or less, and further preferably 5,000 parts by mass or more and 10,000 parts by mass or less of the at least one or more compounds selected from a monomer, a prepolymer and a polymer based on 100 parts by mass of the cellulose fine fiber.

The method for preparing the aqueous dispersion of cellulose fine fiber of the present embodiment is not particularly limited. The aqueous dispersion may be the aqueous dispersion prepared in the step of preparing an aqueous dispersion described in the above section of (Method for producing a cellulose fine fiber composition), or an aqueous dispersion prepared by dispersing the cellulose fine fiber composition described in the above section of (Cellulose fine fiber composition) in water again. The component other than the cellulose fine fiber, the salt and water, for example, at least one or more compounds selected from a monomer, a prepolymer and a polymer may be added at any time during preparation of the aqueous dispersion, and the method is not particularly limited.

The aqueous dispersion of cellulose fine fiber of the present embodiment may be used as a material for preparing a molded article such as film and sheet, for example, by the method described in Examples. In other words, in an embodiment, the aqueous dispersion of cellulose fine fiber is an aqueous dispersion of cellulose fine fiber for a molded article (e.g., an aqueous dispersion of cellulose fine fiber for forming film and sheet). The present disclosure also includes use of the aqueous dispersion of cellulose fine fiber for producing a molded article and use of the aqueous dispersion of cellulose fine fiber for producing film or sheet.

### Polymer Composition

The polymer composition of the present embodiment comprises a cellulose fine fiber, one or more salts selected from a metal salt and an ammonium salt and a polymer, and comprises 0.002 part by mass or more and 10 parts by mass or less of the salt based on 100 parts by mass of the cellulose fine fiber.

The amount of the salt contained in the polymer composition is 0.002 part by mass or more and 10 parts by mass or less, preferably 0.01 part by mass or more and 5 parts by mass or less, and more preferably 0.02 part by mass or more and 1 part by mass or less based on 100 parts by mass of the cellulose fine fiber. The above range is preferred because the salt is dispersed well in the polymer composition.

Examples of polymers contained in the polymer composition include the polymers listed in the above section of (Aqueous dispersion of cellulose fine fiber). The polymer composition comprises preferably 400 parts by mass or more and 20,000 parts by mass or less, more preferably 1,000 parts by mass or more and 15,000 parts by mass or less, and further preferably 5,000 parts by mass or more and 10,000 parts by mass or less of the polymer based on 100 parts by mass of the cellulose fine fiber.

The method for preparing the polymer composition of the present embodiment is not particularly limited. The polymer composition may be prepared by drying the aqueous dispersion of cellulose fine fiber containing a polymer as described in the above section of (Aqueous dispersion of cellulose fine fiber), or by drying an aqueous dispersion of cellulose fine fiber containing a monomer or a prepolymer and, if necessary, heating the aqueous dispersion under conditions in which polymerization of the monomer or the prepolymer proceeds.

### Molded Article

The molded article of the present embodiment has a layer formed from the polymer composition described above. What is needed is that the molded article has a layer formed from the polymer composition, and the molded article may have only a layer formed from the polymer composition (a molded article with a single layer structure) or may have a layer formed from the polymer composition and another layer (a laminate).

For the molded article of the present embodiment, a molded article (laminate) composed of a base material and a layer formed from the polymer composition may be prepared, for example, by forming the polymer composition described above into a specific shape such as a film or a sheet on the base material. Furthermore, a molded article with a single layer structure may be prepared by removing the base material from the molded article (laminate). The form of the molded article of the present embodiment is not particularly limited, and examples thereof include film and sheet.

Examples of base materials include, but are not particularly limited to, polymer, glass, metal, paper and fabric (woven fabric, nonwoven fabric).

### EXAMPLE

Hereinafter the present embodiment will be described with reference to Examples, but the present disclosure is not limited by these Examples.

### Average Fiber Width

The average fiber width of the cellulose fine fiber in Examples and Comparative Examples was calculated by measuring the fiber width of 50 pieces of fiber randomly selected using an atomic force microscope (SPM-9700HT manufactured by SHIMADZU CORPORATION) and arithmetically averaging the values. The evaluation sample prepared by the following method was used.

A powdery cellulose fine fiber composition (sample) was weighed so that the amount of the cellulose fine fiber was 3 g. The sample was added to distilled water amount of which was weighed so that the total amount with the sample was 1,000 g, and the mixture was stirred by using a mixer (G5200 manufactured by Biolomix) for 3 minutes to give a 0.3% by mass homogeneous aqueous dispersion of cellulose fine fiber (aqueous dispersion of cellulose fine fiber). Subsequently, high dispersion treatment was performed by 3 pass processing using a high pressure disperser, i.e., high pressure homogenizer (M-110EH-30 manufactured by Microfluidics) to which a 200 micrometers auxiliary processing module and an 87 micrometers interaction chamber were attached, at 200 MPa. Next, 149.0 g of distilled water was added to 1.0 g of the 0.3% by mass homogeneous aqueous dispersion of cellulose fine fiber after high dispersion treatment, and the mixture was stirred by using a mixer (G5200 manufactured by Biolomix) for 3 minutes to give a 0.002% by mass homogeneous aqueous dispersion of cellulose fine fiber. After that, 30 microliters of the 0.002% by mass homogeneous aqueous dispersion of cellulose fine fiber was dropped on a natural mica (natural muscovite) base material plate (15 mm×15 mm×thickness 0.15 mm) with a micropipette and the dispersion was naturally dried for 0.5 hours to give an evaluation sample.

### Amount of Sulfur Introduced

The amount of sulfur introduced into the cellulose fine fiber (mmol/g) in Examples and Comparative Examples was determined by the following method.

The amount of sulfur introduced into the cellulose fine fiber was quantified by the combustion absorption-IC method using ICS-1500 manufactured by NIPPON DIONEX K.K., The cellulose fine fiber dried (0.01 g) was placed on a magnetic board and burned in an oxygen atmosphere (flow rate: 1.5 L/minute) in a ring furnace (1,350 degrees C.), and the resulting gas component was absorbed into 3% hydrogen peroxide solution (20 ml) to give an absorption solution. Pure water was added to the resulting absorption solution to 100 ml and the diluted solution was subjected to ion chromatography. The concentration of sulfate ions (% by mass) in the cellulose fine fiber was measured based on the results of measurement, and the amount of sulfuric acid introduced into the cellulose fine fiber per 1 g (mmol/g) was calculated. Dried cellulose fine fiber was prepared by drying the aqueous dispersion of cellulose fine fiber in an atmosphere of 105 degrees C. until a constant weight is reached.

### Method for Evaluating Water Content

The moisture content (water content) (% by mass) of the cellulose fine fiber composition (dried cellulose fine fiber) comprising the cellulose fine fiber, a metal salt and an ammonium salt prepared in Examples and Comparative Examples may be represented by the amount of moisture relative to the mass of the cellulose fine fiber composition according to JIS P8203. In short, the moisture content (% by mass) may be calculated by the following equation.

$$Moisture content ( \% by mass ) = ( ( mass of cellulose fine fiber composition - mass of solid content of cellulose fine fiber composition ) / \\ mass of cellulose fine fiber composition ) \times 100$$

(The mass of the cellulose fine fiber composition means the mass (g) of the cellulose fine fiber composition used for the measurement; the mass of the solid content of the cellulose fine fiber composition means the mass (g) of the solid which remains after drying the same amount of a cellulose fine fiber composition as the cellulose fine fiber composition used for the measurement in an atmosphere of 105 degrees C. for 2 hours until a constant weight is reached.)

### Evaluation of Suppression of Separation of Film in Film Forming

### Cellulose Fine Fiber Composition (Dried Cellulose Fine Fiber)

30 g of an aqueous dispersion containing cellulose fine fiber and salt with a solid concentration of 0.5% was poured into a 10 cm×10 cm×3 cm polystyrene resin container, and the dispersion was naturally dried for 5 days to stack a dried film having a thickness of 10 micrometers on polystyrene.

The aqueous dispersion containing cellulose fine fiber and salt with a solid concentration of 0.5% was prepared by dispersing the powdery cellulose fine fiber composition (dried cellulose fine fiber) prepared in Examples 1 to 17 and Comparative Examples 1 to 5 in water.

### Natural Rubber Sheet

The natural rubber sheet with a thickness of 10 micrometers formed on Teflon®, which was prepared in Examples and Comparative Examples, was observed (dried film).

### Urethane Resin Sheet

The urethane resin sheet with a thickness of 10 micrometers formed on Teflon®, which was prepared in Examples and Comparative Examples, was observed (dried film).

### Evaluation of Suppression of Separation of Film

Whether the dried film was separated or not was observed in a room with an illuminance of 750 1× (lux) using a magnifying glass with a magnification of 10 times (MAGDEPO Eye Loupe manufactured by Magnifier Factory), and the outer periphery of the part with film separation was marked by a permanent maker (Mackey pen, extra-fine manufactured by Zebra Co., Ltd.). Next, the entire dried film was peeled off from the polystyrene resin container which was the base material, and weighed with an electronic balance (AUW220D manufactured by SHIMADZU CORPORATION) to measure the total mass of the dried film. Subsequently, the entire part with film separation was cut out with a box cutter along the line which had been marked with the permanent pen on the dried film, and the total amount cut was weighed by the electronic balance (AUW220D manufactured by SHIMADZU CORPORATION) as the part with film separation to measure the mass of the part with film separation. After that, the area ratio of the part with film separation was calculated by: area ratio of part with film separation=mass of part with film separation/mass of entire dried film×100 {%}. Whether the separation of the film was suppressed or not in film forming was evaluated based on the following criteria.
AA: the area ratio of the part with film separation is less than 0.5%
BB: the area ratio of the part with film separation is 0.5% or more and less than 2%
CC: the area ratio of the part with film separation is 2% or more and less than 5%
DD: the area ratio of the part with film separation is 5% or more

### Evaluation of Tensile Strength

The natural rubber sheet or the urethane resin sheet prepared in Examples 18 to 26 and Comparative Examples 6 to 9 were cut into 10 mm wide and 100 mm long by a sample cutter (SDL200 manufactured by DUMBBELL CO., LTD.) to give a dumbbell-shaped sample. Dumbbell-shaped samples of a natural rubber sheet (comparative product) and a urethane resin sheet (comparative product) which do not include cellulose fine fiber were prepared as comparative products by the same method. The natural rubber sheet (comparative product) and the urethane resin sheet (comparative product) were produced by the following method.

The dumbbell-shaped sample was stretched using Tensilon RTF-2410 (manufactured by A&D Company Limited.) according to JIS-C-2151, ASTM-D-882 at a grip distance of 50 mm and a rate of 200 mm/minute, and the strength at break was measured three times, respectively, and the average was calculated.

Next, for the average of the strength at break obtained, the improvement rate of the strength at break of the natural rubber sheet (strength at break of Examples 18, 20, 22, 24 or Comparative Example 6/strength at break of natural rubber sheet (comparative product)) was determined, and the strength at break was evaluated based on the following criteria.

Likewise, the improvement rate of the strength at break of the film of the urethane composite material (strength at break of Examples 19, 21, 23, 25, 26 or Comparative Examples 7 to 9/strength at break of urethane resin sheet (comparative product)) was determined, and the strength at break was evaluated based on the following criteria.
AA: the improvement rate of the strength at break is 2.0 times or more
BB: the improvement rate of the strength at break is 1.2 times or more and less than 2.0 times
CC: the improvement rate of the strength at break is less than 1.2 times

### Method for Producing Natural Rubber Sheet (Comparative Product)

2,000 g of distilled water and 0.3 g of a radical initiator (“Perhexa25B-40” manufactured by NOF CORPORATION) were added to 20 g of natural rubber latex having a solid concentration of 50% by mass (manufactured by KENIS, Ltd.). 20 g of the mixture was put in a 10 cm×10 cm×3 cm Teflon® tray and dried at 80 degrees C. for 3 days to give a natural rubber sheet having a film thickness of 10 micrometers (comparative product).

### Method for Producing Urethane Resin Sheet (Comparative Product)

1,977 g of distilled water and 0.05 g of a blocked isocyanate curing agent (“Duranate 17B-60P” manufactured by Asahi Kasei Corporation) were added to 28.5 g of urethane emulsion having a solid concentration of 35% by mass (UCOAT UWS-145 manufactured by Sanyo Chemical Industries, Ltd.). 20 g of the mixture was put in a 10 cm×10 cm×3 cm Teflon® tray and dried at room temperature for 7 days to give a urethane resin sheet having a film thickness of 10 micrometers (comparative product). The following raw materials were used in Examples and Comparative Examples.

### Raw Materials

DMSO (dimethyl sulfoxide) (manufactured by FUJIFILM Wako Pure Chemical Corporation)
Acetic anhydride (manufactured by FUJIFILM Wako Pure Chemical Corporation)
98% sulfuric acid (manufactured by SANWA KAGAKU CORP.)
Sodium hydroxide (manufactured by FUJIFILM Wako Pure Chemical Corporation)
NaCl (manufactured by FUJIFILM Wako Pure Chemical Corporation)
Sodium acetate (manufactured by FUJIFILM Wako Pure Chemical Corporation)
Sodium sulfate (manufactured by FUJIFILM Wako Pure Chemical Corporation)
Ammonium sulfate (manufactured by FUJIFILM Wako Pure Chemical Corporation)
Calcium acetate monohydrate (manufactured by FUJIFILM Wako Pure Chemical Corporation)
Sodium phosphate (manufactured by FUJIFILM Wako Pure Chemical Corporation)
Lithium tetraborate (manufactured by FUJIFILM Wako Pure Chemical Corporation)
Lithium silicate (manufactured by FUJIFILM Wako Pure Chemical Corporation)
2,2,6,6-tetramethylpiperidine-N-oxyl (manufactured by FUJIFILM Wako Pure Chemical Corporation)
Sodium bromide (manufactured by FUJIFILM Wako Pure Chemical Corporation)

### Example 1

150 g of DMSO, 25 g of acetic anhydride and 3.35 g of 98% sulfuric acid were placed in a 300 ml sample bottle, and the mixture was stirred at a room temperature of 23 degrees C. using a magnetic stirrer for 30 seconds to prepare a defibration solution.

Next, 5.0 g of conifer kraft pulp NBKP (manufactured by NIPPON PAPER INDUSTRIES CO., LTD.) was added to the defibration solution and the mixture was stirred at a room temperature of 23 degrees C. for 120 minutes to perform sulfuric acid esterification. After stirring, 250 ml of distilled water was added to the defibration solution containing cellulose to stop the reaction, and then a 5% by mass aqueous sodium hydroxide solution was added thereto until the pH reached 7 to neutralize the reaction solution. Then the supernatant was removed by centrifugation.

1,350 ml of distilled water and 1,350 ml of ethanol were also added thereto and the mixture was stirred until homogeneously dispersed, and then the supernatant was removed by centrifugation. The same procedure was repeated to wash the solution a total of six times. The rate of centrifugation was 12,000 rpm and the time of centrifugation was 50 minutes in the respective procedures. After washing by centrifugation, distilled water was added thereto to dilute the solution until the total weight reached 1,000 g.

Next, the solution was stirred using a mixer (G5200 manufactured by Biolomix) for 3 minutes to give an aqueous dispersion of cellulose fine fiber having a sulfuric acid ester group (0.5% by mass). The amount of sulfur introduced into the cellulose fine fiber having a sulfuric acid ester group (amount of sulfur introduced which was derived from the sulfuric acid ester group) was 2.5 mmol/g. The cellulose fine fiber having a sulfuric acid ester group is also described as a cellulose fine fiber esterified with sulfuric acid.

0.1 g of a 20% by mass aqueous NaCl solution was added to 400 g of the aqueous dispersion of cellulose fine fiber having a sulfuric acid ester group (0.5% by mass), and the mixture was stirred for 5 minutes with a stirrer to give an aqueous dispersion (1) containing 1 part by mass of NaCl based on 100 parts by mass of the cellulose fine fiber esterified with sulfuric acid.

Next, the resulting aqueous dispersion (1) was dried for 72 hours using a freeze drying apparatus (FDU-2110 manufactured by TOKYO RIKAKIKAI CO., LTD.). Subsequently, the resultant was treated in a dry pulverizer (Wonder Blender WB1 manufactured by OSAKA CHEMICAL Co., Ltd.) for 1 minute to give a powdery cellulose fine fiber composition (dried cellulose fine fiber) (1) containing 1 part by mass of NaCl based on 100 parts by mass of the cellulose fine fiber esterified with sulfuric acid (amount of sulfur introduced 2.5 mmol/g).

### Example 2

A powdery cellulose fine fiber composition (dried cellulose fine fiber) (2) containing 0.002 part by mass of NaCl based on 100 parts by mass of the cellulose fine fiber esterified with sulfuric acid (amount of sulfur introduced 2.5 mmol/g) was prepared in the same manner as in Example 1 except for changing the concentration of the 20% by mass aqueous NaCl solution in Example 1 to 0.04% by mass.

### Example 3

A powdery cellulose fine fiber composition (dried cellulose fine fiber) (3) containing 1 part by mass of sodium sulfate based on 100 parts by mass of the cellulose fine fiber esterified with sulfuric acid (amount of sulfur introduced 2.5 mmol/g) was prepared in the same manner as in Example 1 except for changing the 20% by mass aqueous NaCl solution in Example 1 to a 20% by mass aqueous sodium sulfate solution.

### Example 4

A powdery cellulose fine fiber composition (dried cellulose fine fiber) (4) containing 0.002 part by mass of sodium sulfate based on 100 parts by mass of the cellulose fine fiber esterified with sulfuric acid (amount of sulfur introduced 2.5 mmol/g) was prepared in the same manner as in Example 3 except for changing the concentration of the 20% by mass aqueous sodium sulfate solution in Example 3 to 0.04% by mass.

### Example 5

A powdery cellulose fine fiber composition (dried cellulose fine fiber) (5) containing 1 part by mass of sodium acetate based on 100 parts by mass of the cellulose fine fiber esterified with sulfuric acid (amount of sulfur introduced 2.5 mmol/g) was prepared in the same manner as in Example 1 except for changing the 20% by mass aqueous NaCl solution in Example 1 to a 20% by mass aqueous sodium acetate solution.

### Example 6

A powdery cellulose fine fiber composition (dried cellulose fine fiber) (6) containing 0.002 part by mass of sodium acetate based on 100 parts by mass of the cellulose fine fiber esterified with sulfuric acid (amount of sulfur introduced 2.5 mmol/g) was prepared in the same manner as in Example 5 except for changing the concentration of the 20% by mass aqueous sodium acetate solution in Example 5 to 0.04% by mass.

### Example 7

A powdery cellulose fine fiber composition (dried cellulose fine fiber) (7) containing 1 part by mass of ammonium sulfate based on 100 parts by mass of the cellulose fine fiber esterified with sulfuric acid (amount of sulfur introduced 2.5 mmol/g) was prepared in the same manner as in Example 1 except for changing the 20% by mass aqueous NaCl solution in Example 1 to a 20% by mass aqueous ammonium sulfate solution.

### Example 8

A powdery cellulose fine fiber composition (dried cellulose fine fiber) (8) containing 0.002 part by mass of ammonium sulfate based on 100 parts by mass of the cellulose fine fiber esterified with sulfuric acid (amount of sulfur introduced 2.5 mmol/g) was prepared in the same manner as in Example 7 except for changing the concentration of the 20% by mass aqueous ammonium sulfate solution in Example 7 to 0.04% by mass.

### Example 9

A powdery cellulose fine fiber composition (dried cellulose fine fiber) (9) containing 0.1 part by mass of sodium phosphate based on 100 parts by mass of the cellulose fine fiber esterified with sulfuric acid (amount of sulfur introduced 2.5 mmol/g) was prepared in the same manner as in Example 1 except for changing the 20% by mass aqueous NaCl solution in Example 1 to a 2% by mass aqueous sodium phosphate solution.

### Example 10

A powdery cellulose fine fiber composition (dried cellulose fine fiber) (10) containing 0.1 part by mass of lithium tetraborate based on 100 parts by mass of the cellulose fine fiber esterified with sulfuric acid (amount of sulfur introduced 2.5 mmol/g) was prepared in the same manner as in Example 1 except for changing the 20% by mass aqueous NaCl solution in Example 1 to a 2% by mass aqueous lithium tetraborate solution.

### Example 11

A powdery cellulose fine fiber composition (dried cellulose fine fiber) (11) containing 0.1 part by mass of lithium silicate based on 100 parts by mass of the cellulose fine fiber esterified with sulfuric acid (amount of sulfur introduced 2.5 mmol/g) was prepared in the same manner as in Example 1 except for changing the 20% by mass aqueous NaCl solution in Example 1 to a 2% by mass aqueous lithium silicate solution.

### Example 12

A powdery cellulose fine fiber composition (dried cellulose fine fiber) (12) containing 0.05 part by mass of sodium sulfate and 0.05 part by mass of sodium acetate based on 100 parts by mass of the cellulose fine fiber esterified with sulfuric acid (amount of sulfur introduced 2.5 mmol/g) was prepared in the same manner as in Example 1 except for changing 0.1 g of the 20% by mass aqueous NaCl solution in Example 1 to 0.05 g of a 2% by mass aqueous sodium sulfate solution and 0.05 g of a 2% by mass aqueous sodium acetate solution.

### Example 13

A powdery cellulose fine fiber composition (dried cellulose fine fiber) (13) containing 0.005 part by mass of sodium sulfate and 0.005 part by mass of sodium acetate based on 100 parts by mass of the cellulose fine fiber esterified with sulfuric acid (amount of sulfur introduced 2.5 mmol/g) was prepared in the same manner as in Example 12 except for changing the concentration of the aqueous sodium sulfate solution and the aqueous sodium acetate solution in Example 12 to 0.2% by mass, respectively.

### Example 14

A powdery cellulose fine fiber composition (dried cellulose fine fiber) (14) containing 0.1 part by mass of sodium acetate based on 100 parts by mass of cellulose fine fiber esterified with sulfuric acid (amount of sulfur introduced 0.4 mmol/g) was prepared in the same manner as in Example 5 except that the time of stirring at a room temperature of 23 degrees C. after adding conifer kraft pulp NBKP (manufactured by NIPPON PAPER INDUSTRIES CO., LTD.) to the defibration solution in Example 5 was changed to 30 minutes from 120 minutes and the concentration of the aqueous sodium acetate solution was changed to 2% by mass from 20% by mass.

### Example 15

A powdery cellulose fine fiber composition (dried cellulose fine fiber) (15) containing 0.1 part by mass of sodium acetate based on 100 parts by mass of the cellulose fine fiber esterified with sulfuric acid (amount of sulfur introduced 2.5 mmol/g) was prepared in the same manner as in Example 5 except for changing the concentration of the 20% by mass aqueous sodium acetate solution in Example 5 to 2% by mass.

### Example 16

A powdery cellulose fine fiber composition (dried cellulose fine fiber) (16) containing 0.1 part by mass of sodium acetate based on 100 parts by mass of cellulose fine fiber esterified with sulfuric acid (amount of sulfur introduced 2.8 mmol/g) was prepared in the same manner as in Example 15 except for changing the amount added of 98% sulfuric acid used for preparing the defibration solution in Example 15 to 3.75 g from 3.35 g.

### Comparative Example 1

A powdery cellulose fine fiber composition (dried cellulose fine fiber) (c1) free of salt and containing the cellulose fine fiber esterified with sulfuric acid (amount of sulfur introduced 2.5 mmol/g) was prepared in the same manner as in Example 1 except that the 20% by mass aqueous NaCl solution was not added to 400 g of the aqueous dispersion of cellulose fine fiber having a sulfuric acid ester group (0.5% by mass) in Example 1.

### Comparative Example 2

A powdery cellulose fine fiber composition (dried cellulose fine fiber) (c2) containing 0.1 part by mass of sodium acetate based on 100 parts by mass of cellulose fine fiber esterified with sulfuric acid (amount of sulfur introduced 0.2 mmol/g) was prepared in the same manner as in Example 14 except for changing the amount added of 98% sulfuric acid used for preparing the defibration solution in Example 14 to 1.70 g from 3.35 g.

### Comparative Example 3

A powdery cellulose fine fiber composition (dried cellulose fine fiber) (c3) containing 0.1 part by mass of sodium acetate based on 100 parts by mass of cellulose fine fiber esterified with sulfuric acid (amount of sulfur introduced 3.5 mmol/g) was prepared in the same manner as in Example 15 except for changing the amount added of 98% sulfuric acid used for preparing the defibration solution in Example 15 to 4.69 g from 3.35 g.

### Comparative Example 4

0.13 mmol of 2,2,6,6-tetramethylpiperidine-N-oxyl (TEMPO) and 10 mmol of sodium bromide were dissolved in water to give 250 mL of an aqueous solution.

5 g of conifer kraft pulp NBKP (manufactured by NIPPON PAPER INDUSTRIES CO., LTD.) was added to the aqueous solution and the mixture was stirred until the pulp was homogeneously dispersed. The temperature of the mixture was adjusted to 20 degrees C. and then 32 mmol of an aqueous sodium hypochlorite solution (manufactured by FUJIFILM Wako Pure Chemical Corporation) was added thereto to start oxidation reaction. During the reaction, the temperature of the reaction system was kept at 20 degrees C. and the pH was kept at 10 by sequentially adding a 3N aqueous sodium hydroxide solution. After reacting for 3 hours, the resultant was filtered with a glass filter and the filtrate was thoroughly washed with water. The above operation provided oxidized pulp.

Ion-exchange water was added to the oxidized pulp to adjust the solid concentration of the slurry to 0.5% by mass, and the slurry was treated with an ultrahigh pressure homogenizer at 140 MPa three times to give an aqueous dispersion of TEMPO-oxidized cellulose fine fiber (0.5% by mass).

0.1 g of a 2% by mass aqueous sodium acetate solution was added to 400 g of the aqueous dispersion of the TEMPO-oxidized cellulose fine fiber (0.5% by mass), and the mixture was stirred with a stirrer for 5 minutes to give an aqueous dispersion (c4) containing 0.1 part by mass of sodium acetate based on 100 parts by mass of the TEMPO-oxidized cellulose fine fiber.

Subsequently, the resulting aqueous dispersion (c4) was dried for 72 hours using a freeze drying apparatus (FDU-2110 manufactured by TOKYO RIKAKIKAI CO., LTD.) to give a powdery cellulose fine fiber composition (dried cellulose fine fiber) (c4) containing 0.1 part by mass of sodium acetate based on 100 parts by mass of the TEMPO-oxidized cellulose fine fiber.

### Comparative Example 5

Conifer kraft pulp NBKP (manufactured by NIPPON PAPER INDUSTRIES CO., LTD.) was preliminarily beaten by using a Niagara beater for 2 hours and 30 minutes. Next, defibration treatment was performed twice using a stone mill mechanical de-fibrator (“Super masscolloider” manufactured by MASUKO SANGYO CO., LTD.) to give an aqueous dispersion of cellulose fine fiber (0.5% by mass) prepared by mechanical defibration.

0.1 g of a 2% by mass aqueous sodium acetate solution was added to 400 g of the aqueous dispersion of cellulose fine fiber (0.5% by mass) prepared by mechanical defibration, and the mixture was stirred with a stirrer for 5 minutes to give an aqueous dispersion (c5) containing 0.1 part by mass of sodium acetate based on 100 parts by mass of the cellulose fine fiber prepared by mechanical defibration.

Subsequently, the resulting aqueous dispersion (c5) was dried for 72 hours using a freeze drying apparatus (FDU-2110 manufactured by TOKYO RIKAKIKAI CO., LTD.) to give a powdery cellulose fine fiber composition (dried cellulose fine fiber) (c5) containing 0.1 part by mass of sodium acetate based on 100 parts by mass of the cellulose fine fiber.

### Example 17

A powdery cellulose fine fiber composition (dried cellulose fine fiber) (17) containing 0.1 part by mass of calcium acetate based on 100 parts by mass of the cellulose fine fiber esterified with sulfuric acid (amount of sulfur introduced 2.5 mmol/g) was prepared in the same manner as in Example 1 except for changing the 20% by mass aqueous NaCl solution in Example 1 to a 2% by mass aqueous calcium acetate solution.

The type of the cellulose nanofiber (CNF) contained in the powdery cellulose fine fiber compositions prepared in Examples 1 to 17 and Comparative Examples 1 to 5, their average fiber width, the amount of sulfur introduced thereinto, the type of salt and the amount of the salt based on 100 parts by mass of the fine cellulose are shown in Table 1. The water content in the cellulose fine fiber composition and the results of evaluation of suppression of separation of film in film forming are shown in Table 2.

TABLE 1

| | Cellulose fine fiber composition | | | | |
|---|---|---|---|---|---|
| | | Average | Amount | | Amount of |
| | | fiber | of sulfur | | salt |
| | | width | introduced | Type of | (part by |
| | Type of CNF | (nm) | (mmol/g) | salt | mass) |
| Example 1 | CNF esterified with | 4 | 2.5 | NaCl | 1 |
| | sulfuric acid | | | | |
| Example 2 | CNF esterified with | 3 | 2.5 | NaCl | 0.002 |
| | sulfuric acid | | | | |
| Example 3 | CNF esterified with | 3 | 2.5 | Sodium | 1 |
| | sulfuric acid | | | sulfate | |
| Example 4 | CNF esterified with | 5 | 2.5 | Sodium | 0.002 |
| | sulfuric acid | | | sulfate | |
| Example 5 | CNF esterified with | 4 | 2.5 | Sodium | 1 |
| | sulfuric acid | | | acetate | |
| Example 6 | CNF esterified with | 4 | 2.5 | Sodium | 0.002 |
| | sulfuric acid | | | acetate | |
| Example 7 | CNF esterified with | 3 | 2.5 | Ammonium | 1 |
| | sulfuric acid | | | sulfate | |
| Example 8 | CNF esterified with | 2 | 2.5 | Ammonium | 0.002 |
| | sulfuric acid | | | sulfate | |
| Example 9 | CNF esterified with | 4 | 2.5 | Sodium | 0.1 |
| | sulfuric acid | | | phosphate | |
| Example 10 | CNF esterified with | 5 | 2.5 | Lithium | 0.1 |
| | sulfuric acid | | | tetraborate | |
| Example 11 | CNF esterified with | 3 | 2.5 | Lithium | 0.1 |
| | sulfuric acid | | | silicate | |
| Example 12 | CNF esterified with | 4 | 2.5 | Sodium | 0.05 |
| | sulfuric acid | | | sulfate | |
| | | | | Sodium | 0.05 |
| | | | | acetate | |
| Example 13 | CNF esterified with | 3 | 2.5 | Sodium | 0.005 |
| | sulfuric acid | | | sulfate | |
| | | | | Sodium | 0.005 |
| | | | | acetate | |
| Example 14 | CNF esterified with | 978 | 0.4 | Sodium | 0.1 |
| | sulfuric acid | | | acetate | |
| Example 15 | CNF esterified with | 5 | 2.5 | Sodium | 0.1 |
| | sulfuric acid | | | acetate | |
| Example 16 | CNF esterified with | 2 | 2.8 | Sodium | 0.1 |
| | sulfuric acid | | | acetate | |
| Comparative | CNF esterified with | 3 | 2.5 | — | — |
| Example 1 | sulfuric acid | | | | |
| Comparative | CNF esterified with | 1080 | 0.2 | Sodium | 0.1 |
| Example 2 | sulfuric acid | | | acetate | |
| Comparative | CNF esterified with | 2 | 3.5 | Sodium | 0.1 |
| Example 3 | sulfuric acid | | | acetate | |
| Comparative | TEMPO-oxidized | 2 | — | Sodium | 0.1 |
| Example 4 | CNF | | | acetate | |
| Comparative | mechanically | 85 | — | Sodium | 0.1 |
| Example 5 | defibrated CNF | | | acetate | |
| Example 17 | CNF esterified with | 3 | 2.5 | Calcium | 0.1 |
| | sulfuric acid | | | acetate | |

TABLE 2

| | Cellulose fine fiber | Suppression of |
|---|---|---|
| | composition | separation |
| | Water content | of film in |
| | (% by mass) | film forming |
| Example 1 | 4 | BB |
| Example 2 | 2 | BB |
| Example 3 | 2 | AA |
| Example 4 | 3 | BB |
| Example 5 | 3 | AA |
| Example 6 | 5 | BB |
| Example 7 | 2 | BB |
| Example 8 | 3 | BB |
| Example 9 | 5 | BB |
| Example 10 | 6 | BB |
| Example 11 | 2 | BB |
| Example 12 | 4 | AA |
| Example 13 | 3 | BB |
| Example 14 | 5 | BB |
| Example 15 | 3 | BB |
| Example 16 | 9 | BB |
| Comparative Example 1 | 6 | DD |
| Comparative Example 2 | 4 | DD |
| Comparative Example 3 | 12 | CC |
| Comparative Example 4 | 5 | DD |
| Comparative Example 5 | 11 | DD |
| Example 17 | 5 | BB |

Examples have higher film formability than those of Comparative Examples.

### Example 18

A powdery cellulose fine fiber composition (dried cellulose fine fiber) (18) containing 0.1 part by mass of sodium sulfate based on 100 parts by mass of the cellulose fine fiber esterified with sulfuric acid (amount of sulfur introduced 2.5 mmol/g) was prepared in the same manner as in Example 3 except for changing the concentration of the 20% by mass aqueous sodium sulfate solution in Example 3 to 2% by mass.

Next, 2,150 g of distilled water was added to 0.5 g of the resulting dried cellulose fine fiber (18) and the mixture was stirred with a stirrer for 30 minutes to give an aqueous dispersion. The aqueous dispersion was mixed with 20 g of natural rubber latex with a solid concentration of 50% by mass (manufactured by KENIS Ltd.) and stirred with a stirrer at normal temperature for 1 hour. 0.3 g of a radical initiator (“Perhexa 25B-40” manufactured by NOF Corporation) was added thereto and 20 g of the mixture was put in a 10 cm×10 cm×3 cm Teflon® tray and dried at 80 degrees C. for 3 days to give a 10 micrometer-thick natural rubber sheet containing cellulose fine fiber esterified with sulfuric acid and 0.1 part by mass of sodium sulfate based on 100 parts by mass of the cellulose fine fiber esterified with sulfuric acid on Teflon.

### Example 19

A powdery cellulose fine fiber composition (dried cellulose fine fiber) (19) containing 0.1 part by mass of sodium sulfate based on 100 parts by mass of the cellulose fine fiber esterified with sulfuric acid (amount of sulfur introduced 2.5 mmol/g) was prepared in the same manner as in Example 3 except for changing the concentration of the 20% by mass aqueous sodium sulfate solution in Example 3 to 2% by mass.

Next, 2,127 g of distilled water was added to 0.5 g of the resulting dried cellulose fine fiber (19) and the mixture was stirred with a stirrer for 30 minutes to give an aqueous dispersion. The aqueous dispersion was mixed with 28.5 g of a urethane emulsion with a solid concentration of 35% by mass (UCOAT UWS-145 manufactured by Sanyo Chemical Industries, Ltd.) and stirred with a stirrer at normal temperature for 1 hour. 0.05 g of a blocked isocyanate curing agent (“Duranate 17B-60P” manufactured by Asahi Kasei Corporation) was added thereto and 20 g of the mixture was put in a 10 cm×10 cm×3 cm Teflon® tray and dried at room temperature for 7 days to give a 10 micrometer-thick urethane resin sheet containing cellulose fine fiber esterified with sulfuric acid and 0.1 part by mass of sodium sulfate based on 100 parts by mass of the cellulose fine fiber esterified with sulfuric acid on Teflon.

### Example 20

A 10 micrometer-thick natural rubber sheet containing cellulose fine fiber esterified with sulfuric acid and 0.1 part by mass of sodium acetate based on 100 parts by mass of the cellulose fine fiber esterified with sulfuric acid was prepared on Teflon in the same manner as in Example 18 except for changing the 2% by mass aqueous sodium sulfate solution in Example 18 to a 2% by mass aqueous sodium acetate solution.

### Example 21

A 10 micrometer-thick urethane resin sheet containing cellulose fine fiber esterified with sulfuric acid and 0.1 part by mass of sodium acetate based on 100 parts by mass of the cellulose fine fiber esterified with sulfuric acid was prepared on Teflon in the same manner as in Example 19 except for changing the 2% by mass aqueous sodium sulfate solution in Example 19 to a 2% by mass aqueous sodium acetate solution.

### Example 22

A 10 micrometer-thick natural rubber sheet containing cellulose fine fiber esterified with sulfuric acid, 0.05 part by mass of sodium sulfate and 0.05 part by mass of sodium acetate based on 100 parts by mass of the cellulose fine fiber esterified with sulfuric acid was prepared on Teflon in the same manner as in Example 18 except for changing 0.1 g of the 2% by mass aqueous sodium sulfate solution in Example 18 to 0.05 g of a 2% by mass aqueous sodium sulfate solution and 0.05 g of a 2% by mass aqueous sodium acetate solution.

### Example 23

A 10 micrometer-thick urethane resin sheet containing cellulose fine fiber esterified with sulfuric acid, 0.05 part by mass of sodium sulfate and 0.05 part by mass of sodium acetate based on 100 parts by mass of the cellulose fine fiber esterified with sulfuric acid was prepared on Teflon in the same manner as in Example 19 except for changing 0.1 g of the 2% by mass aqueous sodium sulfate solution in Example 19 to 0.05 g of a 2% by mass aqueous sodium sulfate solution and 0.05 g of a 2% by mass aqueous sodium acetate solution.

### Example 24

A 10 micrometer-thick natural rubber sheet containing cellulose fine fiber esterified with sulfuric acid and 0.1 part by mass of ammonium sulfate based on 100 parts by mass of the cellulose fine fiber esterified with sulfuric acid was prepared on Teflon in the same manner as in Example 18 except for changing the 2% by mass aqueous sodium sulfate solution in Example 18 to a 2% by mass aqueous ammonium sulfate solution.

### Example 25

A 10 micrometer-thick urethane resin sheet containing cellulose fine fiber esterified with sulfuric acid and 0.1 part by mass of ammonium sulfate based on 100 parts by mass of the cellulose fine fiber esterified with sulfuric acid was prepared on Teflon in the same manner as in Example 19 except for changing the 2% by mass aqueous sodium sulfate solution in Example 19 to a 2% by mass aqueous ammonium sulfate solution.

### Comparative Example 6

A 10 micrometer-thick natural rubber sheet containing cellulose fine fiber esterified with sulfuric acid was prepared on Teflon in the same manner as in Example 18 except that the 2% by mass aqueous sodium sulfate solution in Example 18 was not added.

### Comparative Example 7

A 10 micrometer-thick urethane resin sheet containing cellulose fine fiber esterified with sulfuric acid was prepared on Teflon in the same manner as in Example 19 except that the 2% by mass aqueous sodium sulfate solution in Example 19 was not added.

### Comparative Example 8

0.13 mmol of 2,2,6,6-tetramethylpiperidine-N-oxyl (TEMPO) and 10 mmol of sodium bromide were dissolved in water to give 250 mL of an aqueous solution.

5 g of conifer kraft pulp NBKP (manufactured by NIPPON PAPER INDUSTRIES CO., LTD.) was added to the aqueous solution and the mixture was stirred until the pulp was homogeneously dispersed. The temperature of the mixture was adjusted to 20 degrees C. and then 32 mmol of an aqueous sodium hypochlorite solution (manufactured by FUJIFILM Wako Pure Chemical Corporation) was added thereto to start oxidation reaction. During the reaction, the temperature of the reaction system was kept at 20 degrees C. and the pH was kept at 10 by sequentially adding a 3N aqueous sodium hydroxide solution. After reacting for 3 hours, the resultant was filtered with a glass filter and the filtrate was thoroughly washed with water. The above operation provided oxidized pulp.

Ion-exchange water was added to the oxidized pulp to adjust the solid concentration of the slurry to 0.5% by mass, and the slurry was treated with an ultrahigh pressure homogenizer at 140 MPa three times to give an aqueous dispersion of TEMPO-oxidized cellulose fine fiber (0.5% by mass).

0.1 g of a 2% by mass aqueous sodium acetate solution was added to 400 g of the aqueous dispersion of the TEMPO-oxidized cellulose fine fiber (0.5% by mass), and the mixture was stirred with a stirrer for 5 minutes to give an aqueous dispersion (c8) containing 0.1 part by mass of sodium acetate based on 100 parts by mass of the TEMPO-oxidized cellulose fine fiber.

Subsequently, the resulting aqueous dispersion (c8) was dried for 72 hours using a freeze drying apparatus (FDU-2110 manufactured by TOKYO RIKAKIKAI CO., LTD.) to give a powdery cellulose fine fiber composition (dried cellulose fine fiber) (c8) containing 0.1 part by mass of sodium acetate based on 100 parts by mass of the TEMPO-oxidized cellulose fine fiber.

Next, 2,127 g of distilled water was added to 0.5 g of the resulting dried cellulose fine fiber (c8) and the mixture was stirred with a stirrer for 30 minutes to give an aqueous dispersion. The aqueous dispersion was mixed with 28.5 g of a urethane emulsion with a solid concentration of 35% by mass (UCOAT UWS-145 manufactured by Sanyo Chemical Industries, Ltd.) and stirred with a stirrer at normal temperature for 1 hour. 0.05 g of a blocked isocyanate curing agent (“Duranate 17B-60P” manufactured by Asahi Kasei Corporation) was added thereto and 20 g of the mixture was put in a 10 cm×10 cm×3 cm Teflon® tray and dried at room temperature for 7 days to give a 10 micrometer-thick urethane resin sheet containing TEMPO-oxidized cellulose fine fiber and 0.1 part by mass of sodium acetate based on 100 parts by mass of the TEMPO-oxidized cellulose fine fiber on Teflon.

### Comparative Example 9

Conifer kraft pulp NBKP (manufactured by NIPPON PAPER INDUSTRIES CO., LTD.) was preliminarily beaten by using a Niagara beater for 2 hours and 30 minutes. Next, defibration treatment was performed twice using a stone mill mechanical de-fibrator (“Super masscolloider” manufactured by MASUKO SANGYO CO., LTD.) to give an aqueous dispersion of cellulose fine fiber (0.5% by mass) prepared by mechanical defibration.

0.1 g of a 2% by mass aqueous sodium acetate solution was added to 400 g of the aqueous dispersion of cellulose fine fiber (0.5% by mass) prepared by mechanical defibration, and the mixture was stirred with a stirrer for 5 minutes to give an aqueous dispersion (c9) containing 0.1 part by mass of sodium acetate based on 100 parts by mass of the cellulose fine fiber prepared by mechanical defibration.

Subsequently, the resulting aqueous dispersion (c9) was dried for 72 hours using a freeze drying apparatus (FDU-2110 manufactured by TOKYO RIKAKIKAI CO., LTD.) to give a powdery cellulose fine fiber composition (dried cellulose fine fiber) (c9) containing 0.1 part by mass of sodium acetate based on 100 parts by mass of the cellulose fine fiber.

Next, 2,127 g of distilled water was added to 0.5 g of the resulting dried cellulose fine fiber (c9) and the mixture was stirred with a stirrer for 30 minutes to give an aqueous dispersion. The aqueous dispersion was mixed with 28.5 g of a urethane emulsion with a solid concentration of 35% by mass (UCOAT UWS-145 manufactured by Sanyo Chemical Industries, Ltd.) and stirred with a stirrer at normal temperature for 1 hour. 0.05 g of a blocked isocyanate curing agent (“Duranate 17B-60P” manufactured by Asahi Kasei Corporation) was added thereto and the mixture was put in a 10 cm×10 cm×3 cm Teflon® tray and dried at room temperature for 7 days to give a 10 micrometer-thick urethane resin sheet containing cellulose fine fiber prepared by mechanical defibration and 0.1 part by mass of sodium acetate based on 100 parts by mass of the cellulose fine fiber prepared by mechanical defibration on Teflon.

### Example 26

A 10 micrometer-thick urethane resin sheet containing cellulose fine fiber esterified with sulfuric acid and 0.1 part by mass of calcium acetate based on 100 parts by mass of the cellulose fine fiber esterified with sulfuric acid was prepared on Teflon in the same manner as in Example 19 except for changing the 2% by mass aqueous sodium sulfate solution in Example 19 to a 2% by mass aqueous calcium acetate solution.

The type of the cellulose fine fiber (CNF) contained in the powdery cellulose fine fiber composition prepared in Examples 18 to 26 and Comparative Examples 6 to 9, their average fiber width, the amount of sulfur introduced thereinto, the type of salt and the amount of the salt based on 100 parts by mass of the fine cellulose are shown in Table 3. The materials used for forming sheet (natural rubber or urethane rubber), the results of evaluation of suppression of separation of film in film forming and the results of evaluation of tensile strength are shown in Table 4.

TABLE 3

| | Cellulose fine fiber composition | | | | |
|---|---|---|---|---|---|
| | | Average | Amount of | | Amount |
| | | fiber | sulfur | | of salt |
| | | width | introduced | Type of | (part by |
| | Type of CNF | (nm) | (mmol/g) | salt | mass) |
| Example 18 | CNF esterified | 4 | 2.5 | Sodium | 0.1 |
| | with sulfuric acid | | | sulfate | |
| Example 19 | CNF esterified | 3 | 2.5 | Sodium | 0.1 |
| | with sulfuric acid | | | sulfate | |
| Example 20 | CNF esterified | 5 | 2.5 | Sodium | 0.1 |
| | with sulfuric acid | | | acetate | |
| Example 21 | CNF esterified | 5 | 2.5 | Sodium | 0.1 |
| | with sulfuric acid | | | acetate | |
| Example 22 | CNF esterified | 4 | 2.5 | Sodium | 0.05 |
| | with sulfuric acid | | | sulfate | |
| | | | | Sodium | 0.05 |
| | | | | acetate | |
| Example 23 | CNF esterified | 3 | 2.5 | Sodium | 0.05 |
| | with sulfuric acid | | | sulfate | |
| | | | | Sodium | 0.05 |
| | | | | acetate | |
| Example 24 | CNF esterified | 2 | 2.5 | Ammonium | 0.1 |
| | with sulfuric acid | | | sulfate | |
| Example 25 | CNF esterified | 4 | 2.5 | Ammonium | 0.1 |
| | with sulfuric acid | | | sulfate | |
| Comparative | CNF esterified | 4 | 2.5 | — | — |
| Example 6 | with sulfuric acid | | | | |
| Comparative | CNF esterified | 4 | 2.5 | — | — |
| Example 7 | with sulfuric acid | | | | |
| Comparative | TEMPO-oxidized | 2 | — | Sodium | 0.1 |
| Example 8 | CNF | | | acetate | |
| Comparative | Mechanically | 75 | — | Sodium | 0.1 |
| Example 9 | defibrated CNF | | | acetate | |
| Example 26 | CNF esterified | 3 | 2.5 | Calcium | 0.1 |
| | with sulfuric acid | | | acetate | |

TABLE 4

| | | Suppression of | |
|---|---|---|---|
| | | separation of | |
| | | film in film | Tensile |
| | Material | forming | strength |
| Example 18 | Natural rubber | BB | AA |
| Example 19 | Urethane resin | BB | AA |
| Example 20 | Natural rubber | BB | AA |
| Example 21 | Urethane resin | BB | AA |
| Example 22 | Natural rubber | BB | AA |
| Example 23 | Urethane resin | BB | AA |
| Example 24 | Natural rubber | BB | AA |
| Example 25 | Urethane resin | BB | AA |
| Comparative Example 6 | Natural rubber | DD | CC |
| Comparative Example 7 | Urethane resin | DD | CC |
| Comparative Example 8 | Urethane resin | DD | CC |
| Comparative Example 9 | Urethane resin | DD | CC |
| Example 26 | Urethane resin | BB | AA |

It was confirmed that the systems including rubber or resin of Examples also have higher film formability than those of Comparative Examples, and further that the strength is obviously improved in Examples compared to Comparative Examples.

The upper limit and/or the lower limit of the numerical range described in the present specification may be optionally combined to specify a preferred range, respectively. For example, the upper limit and the lower limit of a numerical range may be optionally combined to specify a preferred range, upper limits of a numerical range may be optionally combined to specify a preferred range, and lower limits of a numerical range may be optionally combined to specify a preferred range. Furthermore, in the present application, the numerical range described using “to” includes each of the values written before and after “to” as the lower limit and the upper limit.

Singular expressions should be construed as inclusive of plural expressions thereof throughout the present specification unless otherwise specified. Articles for singulars (e.g., “a”, “an” and “the” in English) should be construed as including plural meanings unless otherwise specified.

The present embodiment has been described in detail above, but the specific structures are not limited to the embodiment. The present disclosure encompasses design changes if any, which do not depart from the subject matter of the present disclosure.

All publications, patents and patent applications cited in the present specification are incorporated herein by reference in their entirety.

1. A cellulose fine fiber composition comprising cellulose fine fiber and one or more salts selected from a metal salt and an ammonium salt, wherein
the cellulose fine fiber has an average fiber width of 1 nm or more and 1,000 nm or less,
the cellulose fine fiber has a sulfuric acid ester group represented by the following general formula (1),
the cellulose fine fiber has an amount of sulfur derived from the sulfuric acid ester group of 0.3 mmol/g or more and 3.0 mmol/g or less introduced into the cellulose fine fiber, and
the cellulose fine fiber composition comprises 0.002 part by mass or more and 10 parts by mass or less of the salt based on 100 parts by mass of the cellulose fine fiber: 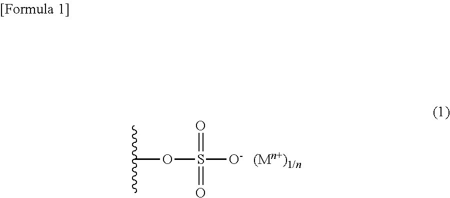
(in the general formula (1), n is an integer of 1 or more and 3 or less, Mⁿ⁺ is an n-valent cation, and the wavy line indicates a bonding site with another atom).

2. The cellulose fine fiber composition according to claim 1, wherein the salt is one or more salts selected from a sulfate, a carboxylate, a borate, a phosphate and an ammonium salt.

3. The cellulose fine fiber composition according to claim 1, having a water content of 10% by mass or less.

4. The cellulose fine fiber composition according to claim 1, which is in a powdery form.

5. An aqueous dispersion of cellulose fine fiber, comprising cellulose fine fiber, one or more salts selected from a metal salt and an ammonium salt, and water, wherein
the cellulose fine fiber has an average fiber width of 1 nm or more and 1,000 nm or less,
the cellulose fine fiber has a sulfuric acid ester group represented by the following general formula (1),
the cellulose fine fiber has an amount of sulfur derived from the sulfuric acid ester group of 0.3 mmol/g or more and 3.0 mmol/g or less introduced into the cellulose fine fiber,
the aqueous dispersion of cellulose fine fiber comprises 0.002 part by mass or more and 10 parts by mass or less of the salt based on 100 parts by mass of the cellulose fine fiber and
the aqueous dispersion of cellulose fine fiber comprises 10 parts by mass or more of water based on 1 part by mass of the total amount of the cellulose fine fiber and the salts: 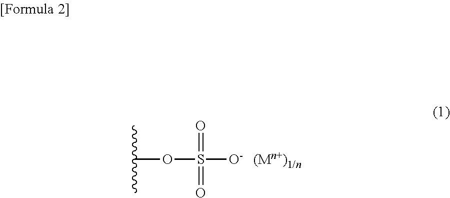
(in the general formula (1), n is an integer of 1 or more and 3 or less, Mⁿ⁺ is an n-valent cation, and the wavy line indicates a bonding site with another atom).

6. The aqueous dispersion of cellulose fine fiber according to claim 5, wherein the salt is one or more salts selected from a sulfate, a carboxylate, a borate, a phosphate and an ammonium salt.

7. The aqueous dispersion of cellulose fine fiber according to claim 5, comprising at least one or more compounds selected from a monomer, a prepolymer and a polymer.

8. The aqueous dispersion of cellulose fine fiber according to claim 7, comprising 400 parts by mass or more and 20,000 parts by mass or less of the at least one or more compounds selected from a monomer, a prepolymer and a polymer based on 100 parts by mass of the cellulose fine fiber.

9. A polymer composition comprising cellulose fine fiber, one or more salts selected from a metal salt and an ammonium salt and a polymer, wherein
the cellulose fine fiber has an average fiber width of 1 nm or more and 1,000 nm or less,
the cellulose fine fiber has a sulfuric acid ester group represented by the following general formula (1),
the cellulose fine fiber has an amount of sulfur derived from the sulfuric acid ester group of 0.3 mmol/g or more and 3.0 mmol/g or less introduced into the cellulose fine fiber, and
the polymer composition comprises 0.002 part by mass or more and 10 parts by mass or less of the salt based on 100 parts by mass of the cellulose fine fiber: 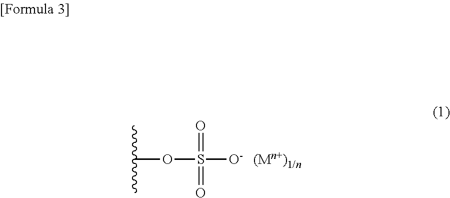
(in the general formula (1), n is an integer of 1 or more and 3 or less, Mⁿ⁺ is an n-valent cation, and the wavy line indicates a bonding site with another atom).

10. The polymer composition according to claim 9, wherein the salt is one or more salts selected from a sulfate, a carboxylate, a borate, a phosphate and an ammonium salt.

11. The polymer composition according to claim 9, comprising 400 parts by mass or more and 20,000 parts by mass or less of the polymer based on 100 parts by mass of the cellulose fine fiber.

12. A molded article comprising a layer formed from the polymer composition according to claim 9.

13. A method for producing the cellulose fine fiber composition according to claim 1, the method comprising the steps of:
preparing an aqueous dispersion of cellulose fine fiber by mixing an aqueous solution of one or more salts selected from a metal salt and an ammonium salt with cellulose fine fiber; and
drying the aqueous dispersion of cellulose fine fiber to obtain a cellulose fine fiber composition comprising the cellulose fine fiber and one or more salts selected from a metal salt and an ammonium salt, wherein
the cellulose fine fiber has an average fiber width of 1 nm or more and 1,000 nm or less,
the cellulose fine fiber has a sulfuric acid ester group represented by the following general formula (1),
the cellulose fine fiber has an amount of sulfur derived from the sulfuric acid ester group of 0.3 mmol/g or more and 3.0 mmol/g or less introduced into the cellulose fine fiber, and
in the step of preparing an aqueous dispersion of cellulose fine fiber, 0.002 part by mass or more and 10 parts by mass or less of the salt based on 100 parts by mass of the cellulose fine fiber is used: 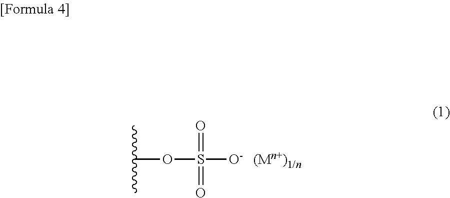
(in the general formula (1), n is an integer of 1 or more and 3 or less, Mn+ is an n-valent cation, and the wavy line indicates a bonding site with another atom).
